(19) United States
(12) Patent Application Publication
(10) Pub. No.: US 2024/0300092 A1
(43) Pub. Date: Sep. 12, 2024

(54) METHOD FOR TRANSFERRING PRODUCTS WITH IMPROVED EFFICIENCY BY MEANS OF A ROBOT, AND STORAGE AND ORDER-PICKING SYSTEM THEREFOR

(71) Applicant: TGW Logistics Group GmbH, Marchtrenk (AT)

(72) Inventors: Timothy LINDLEY, Schwerte (DE); Gerald KETTLGRUBER, Linz (AT)

(73) Assignee: TGW Logistics Group GmbH, Marchtrenk (AT)

(21) Appl. No.: 18/269,000

(22) PCT Filed: Dec. 22, 2021
(86) PCT No.: PCT/AT2021/060485

§ 371 Date: Jun. 22, 2023

(30) Foreign Application Priority Data
Dec. 23, 2020 (AT) A 51139/2020

(51) Int. Cl. B25J 9/16; B25J 9/00; B25J 15/04; B65G 1/137

(52) U.S. Cl. CPC B25J 9/1612; B25J 9/0093; B25J 15/04; B65G 1/1373

(57) ABSTRACT

In a method for transferring goods using a robot and a storage and picking system for carrying out the method, a gripper is coupled to or activated at a robot head of the robot depending on the grip type of the goods to be transferred. By doing so, a good can be picked up at a first position and deposited at a second position. The goods, separated into the groups of goods, are supplied to the robot so that the goods of a first group of goods are firstly provided at the first position and subsequently the goods of a second group of goods are provided at the first position. The first group of goods includes the goods of a first grip type, and the second group of goods includes the goods of a second grip type.

### CROSS REFERENCE TO RELATED APPLICATIONS

This application is the National Stage of PCT/AT2021/060485 filed on Dec. 22, 2021, which claims priority under 35 U.S.C. § 119 of Austrian Application No. A 51139/2020, filed on Dec. 23, 2020, the disclosure of which is incorporated by reference. The international application under PCT article 21(2) was not published in English.

### BACKGROUND OF THE INVENTION

### 1. Field of the Invention

The invention relates to an operating method of a robot for transferring different goods in a storage and picking system, in which
a) grip types for the different goods are determined in an electronic control system, wherein the grip type indicates with which gripper corresponding to which gripper type gripping of the respective good is possible
b) the robot is provided with grippers of different gripper types
c) the electronic control system selects a gripper from the different gripper types depending on the grip type of the good to be transferred
d) the selected gripper is coupled to a robot head of the robot or the selected gripper on a robot head of the robot is activated
e) the goods are provided at a first position in the region of action of the robot and
f) the good is gripped with the selected gripper on the robot at the first position and deposited at a second position in the region of action of the robot.

The invention further relates to a storage and picking system, which
comprises a robot for transferring goods, having a robot head and at least two different grippers, which can be alternately coupled to the robot head, or at least two different grippers arranged on the robot head, which can be alternately activated, and
comprises an electronic control system, which is configured to determine the grip types for the different goods, wherein the grip type indicates with which gripper corresponding to which gripper type gripping of the respective good is possible, and which is further configured to select a provided gripper from the different grip types on the robot depending on the grip type of the good to be transferred and trigger coupling of the selected gripper to the robot head or activating the selected gripper on the robot head and
comprises a conveyor system, which is configured to transport goods to a first position in a region of action of the robot
wherein the robot is configured to grip the good with the selected gripper at the first position in the region of action of the robot and to deposit the good at a second position in the region of action of the robot.

### 2. Description of the Related Art

This type of method and this type of storage and picking system are known in the prior art. These can be used, for example, for picking and/or sorting goods. The large variety of goods means that different grippers have to be used on the robot in order to be able to manipulate the goods safely and at high speed. However, changing the gripper leads to an undesired standstill in the flow of goods because it is not possible to manipulate goods during the change.

### SUMMARY OF THE INVENTION

A problem to be solved by the invention is therefore to provide an improved method and an improved storage and picking system. In particular, interruptions in the flow of goods should be kept to a bare minimum.

The problem of the invention is solved by a method of the aforementioned type, further including the steps:
sorting the different goods into groups of goods depending on grip type, of which a first group of goods comprises goods of a first grip type of the grip types and a second group of goods goods of a second grip type of the grip types and
supplying the goods to the robot separated into the groups of goods, so that the goods of the first groups of goods are firstly provided at the first position and subsequently the goods of the second group of goods at the first position.

Furthermore, the problem of the invention is solved by a storage and picking system of the aforementioned type, in which the conveyor system is further configured to supply the goods, separated into groups of goods, to the robot, wherein the goods of a first group of goods are firstly provided at the first position and subsequently the goods of a second group of goods at the first position, wherein the first group of goods comprises goods of a first grip type of the grip types and the second group of goods goods of a second grip type of the grip types.

By forming the groups of goods, the number of gripper changes can be reduced to a minimum, even if there is an extremely broad range of goods and a correspondingly high number of different goods. The higher the number of goods in a group of goods, the more seldom the need for a gripper change.

The term “gripper” should be understood broadly in the context of the invention and comprises not only gripping tools with gripping fingers or pincer-type gripping tools but also, in particular, suction grippers, which grip or pick up a good using negative pressure.

For example, a gripper can therefore
be a force-locking gripper such as a suction gripper, in particular a vacuum suction gripper with a suction cup or a vacuum suction gripper with a plurality of suction cups, for example
a form-locking gripper such as a finger gripper, in particular a finger gripper with two gripping fingers or a finger gripper with three gripping fingers or a combination gripper comprising a force-locking gripper and a form-locking gripper.

The different types of gripper are described by the respectively allocated “gripper type”. For example, a first gripper type can be allocated to a vacuum suction gripper with a suction cup and a second gripper type to a vacuum suction gripper with a plurality of suction cups etc. In the same way, a first gripper type can be allocated to a finger gripper with two gripping fingers and a second gripping type to a finger gripper with three gripping fingers etc. different combination grippers can be allocated to different gripper types in the same way.

In other words, a different interpretation of the grippers within the same operating principle or within the same gripping technology (for example a varying number of suction cups for suction grippers) can lead to different gripper types. Of course, it is also possible that different operating principles or gripping technologies (for example suction grippers vs. clamp grippers) lead to different gripper types.

The storage and picking system comprises at least two different grippers in the context of the invention. In other words, the storage and picking system thus comprises at least two grippers of different gripper types.

On the one hand, the different grippers can be located in a magazine in the region of action of the robot and are removed from there as required and connected to the robot head. On the other hand, however, the grippers can also be arranged permanently on the robot head and activated if necessary. For example, they can be arranged in a turret magazine on the robot head. In this context, it is noted that the term “activation” of a gripper must not be equated with the term “gripping” (with the gripper), but merely means transferring a gripper from a passive state, in which gripping is not possible, to a standby state, which enables gripping. Passive or non-active grippers are therefore unable to grip. The same applies to the term “coupling” of a gripper.

The “grip type” specifies those goods that can be gripped with a specific gripper corresponding to a specific gripper type. At the same time, the grip type is the sorting criterion for forming a group of goods. If a grip type is allocated to each good, one exact solution exists for forming a group of goods. If several grip types are allocated to some or all goods, several possibilities exist for forming a group of goods. It is conceivable, for example, that a grip type is selected in such a case, which offers the most overlap. If grip types A and B are, for example, allocated to a first good (good 1) and grip types B and C to a second good (good 2), grip type B is an advantageous selection for both goods (goods 1 and 2).

While the grip type characterizes the goods, the gripper type corresponding to the grip type characterizes the gripper of a robot. The grip type and gripper type can therefore be directly allocated to each other in terms of a 1:1 relationship. In a storage and picking system, there may be a plurality of grippers of the same gripper type, for example distributed across a plurality of robots. A plurality of grippers of a gripper type can also be assigned to a single robot, for example, in order to have a reserve in the event of a fault.

The grip type is influenced on the one hand by the properties of the gripper of the assigned gripper type, but on the other hand also by the “good properties” of the good to be gripped. It should be mentioned that a good fundamentally has good properties, which can influence grippability, and those that fundamentally have no influence on grippability. Examples of good properties that can influence grippability are the flexural strength of the good, the fragility of the good, the density of the good, the weight of the good, the surface shape of the good, the surface roughness of the good, the surface permeability of the good, etc. Examples of good properties that generally do not affect grippability are the color of the good, the degree of reflection of the good surface, etc.

One or more good properties define a “good type”. A first good type can comprise flexurally weak goods, a second good type can comprise flexurally rigid goods, etc. A flexurally weak good is, for example, a T-shirt in a plastic bag. A flexurally rigid good is, for example, a pair of shoes in a cardboard box. However, goods of different good types can be allocated to the same grip type. An example would be a shirt and a T-shirt, which are each packed in a plastic bag and can therefore be gripped in the same manner.

The grip type allocated to a good is stored, for example, in the master data for a good, in particular in addition to further data, which characterize a good type of the good. In principle, it is also possible for a plurality of grip types to be stored for a good or a good type if gripping the good is possible with a plurality of grippers or gripper types.

Determining the grip type of a good can be carried out by identifying the good after reading a data carrier. The data carrier can be read on a reader connected to the control system. The data carrier is, for example, a barcode, matrix code, in particular a QR code (quick-response code), data matrix code, RFID (radio frequency identification) tag and the like. The reader can be an optical or optoelectronic reader, with which the data can be machine read. The data carrier can contain data, in particular an identification number, on whose basis access to the master data can be gained, in which the grip type for the good is stored. However, the data carrier can also directly contain data about the grip type.

Yet determining the grip type of a good can also be carried out by recognizing the good by means of “object recognition”. Object recognition describes a method for identifying an object (which corresponds to a good) by means of optical, acoustic or other physical recognition methods. In particular, after the goods are identified by object recognition, the master data can be accessed, in which the grip type for the good is stored.

The term “provision” of the goods in the region of action of the robot includes, in particular, supplying the goods to the region of action of the robot.

The term “delivery” of goods includes both discarding goods and setting down goods.

The control system is, in particular, a higher-level control system and not necessarily a robot controller.

Further advantageous embodiments and advancements of the invention can be found in the subclaims as well as a combination of the description with the figures.

It is advantageous for the goods to be sorted within a group of goods according to a good type in an article-by-article manner. Accordingly, the good type forms a sorting criterion subordinate to the gripper type, leading to blocks of goods of the same good type resulting within a group of goods. For example, shirts and T-shirts can form blocks separate to one another within a group of goods. This embodiment is advantageous, for example, at incoming goods if goods are to be stored in an article-by-article manner. Furthermore, this embodiment is particularly advantageous for picking goods in the B2B sector, since many goods of a good type are often ordered in this sector, which are subsequently stored in a shop in an article-by-article manner.

However, it is also advantageous for the goods to be arranged chaotically within a group of goods with regard to a good type of the goods. In this embodiment, the good type does not form a sorting criterion within a group of goods. Shirts and T-shirts can, for example, be arranged in a mixed manner within a group of goods. This embodiment is advantageous, for example, at incoming goods if goods are to be stored in chaotically. Furthermore, this embodiment is particularly advantageous for picking goods in the e-commerce or B2C sector, since few goods of many different good types are often ordered in these sectors, which are packed as a block in a shipping box.

It is particularly advantageous for sequencing of the groups of goods to be carried out depending on the gripper type of a gripper currently activated or coupled in the robot, wherein goods of the first group of goods have a grip type, which corresponds to the gripper type of the gripper currently activated or coupled in the robot. In this case, when the goods are supplied to the robot, care is taken that those goods, which can be gripped by the gripper currently activated in the robot or by the gripper coupled to the robot, are served first to the robot. In this way, changing the gripper is advantageously avoided.

However, it is also advantageous for sequencing of the groups of goods to be carried out independently of the gripper type of the gripper currently activated or coupled in the robot. In this case, when the goods are supplied to the robot, care is not taken that those goods, which can be gripped by the gripper currently activated in the robot or by the gripper coupled to the robot, are served first to the robot. Because of this, changing the gripper may be necessary to grip goods of the first group of goods. This variant of the method is advantageous if the goods of the first group of goods are to be processed in a prioritized manner and a possible gripper change is accepted.

It is favorable for sorting the different goods into groups of goods to be carried out, depending on the grip type, by an automatic sorting device, which, in turn, is connected to the electronic control system in order to control the automatic sorting device. Accordingly, it is also advantageous for the storage and picking system to comprise an automatic sorting device connected to the conveyor system by conveying technology or an automatic sorting device comprising the conveyor system, wherein the sorting device is connected to the electronic control system by control technology and is controlled by the control system in such a way that the different goods are sorted into groups of goods depending on the grip type. Automatic sorting achieves particularly high sorting performance, thus enabling uninterrupted provision of the goods at the first position.

Furthermore, it is favorable for the automatic sorting device to comprise a suspended conveyor system and suspended bags, wherein the goods are stored in the suspended bags. Accordingly, it is also advantageous for the conveyor system to comprise a suspended conveyor system for transporting the suspended bags from the automatic sorting device to the first position or to be formed by such a suspended conveyor system. The sorting device can comprise one or more sorting stages. If there are several sorting stages, the sorting stages are connected by conveying technology. Each sorting stage comprises a feed line, a discharge line and one or more sorting lines between them. The feed line, discharge line and sorting line(s) are formed by a suspended conveyor system. The goods are selectively supplied from the feed line into the sorting lines and selectively discharged from the sorting lines into the discharge line. The sorting device is formed, for example, by a matrix sorter.

However, in addition to sorting in a dedicated sorting device, sorting can also be carried out in another way, for example by removing goods from a warehouse in a specific sequence or grouping, rendering subsequent sorting or grouping obsolete. Sorting or grouping can also be performed by controlling switches and mergers in the course of the conveyor system or conveyor device. In addition, buffer locations can be used, which are connected to the conveyor system or conveyor device. This enables, for example, removing individual objects from the conveying flow and later reinserting them at a suitable location. Accordingly, the term “conveyor system” comprises a device for providing goods separated into groups of goods in general form.

It is also advantageous for only a single good to be stored in each suspended bag. This measure facilitates removal of the good from the suspended bag.

It is also favorable for the automatic sorting device to comprise a container conveyor system and containers, wherein the goods are stored in the containers. Accordingly, it is also advantageous for the conveyor system to comprise a container conveyor system for transporting the containers from the automatic sorting device to the first position or to be formed by such a container conveyor system. The sorting device can comprise one or more sorting stages. If there are several sorting stages, the sorting stages are connected by conveying technology. Each sorting stage comprises a feed line, a discharge line and one or more sorting lines between them. The feed line, discharge line and sorting line(s) are formed by a container conveyor system. The goods are selectively supplied from the feed line into the sorting lines and selectively discharged from the sorting lines into the discharge line.

It is also particularly advantageous for only goods of a single grip type to be stored in each container. For containers “divided into compartments”, it can also be provided that goods of single grip type are stored in each compartment of the container. Containers “divided into compartments” therefore comprise at least one receiving compartment that receives goods of the same grip type, which are correspondingly allocated to a first or second group of goods. The proposed measures mean that the gripper need not be changed when goods are removed from a container or from a container compartment.

At this point, it is noted that, in accordance with the measures proposed for this variant, although only goods of a single grip type are stored in a container or container compartment, this does not necessarily mean that the goods are stored in the container or container compartment in an article-by-article manner with regard to the good types of the goods. However, it would of course also be possible to store the goods per container or container compartment in an article-by-article manner.

“Article by article” means that goods stored in a container are of the same group of goods. For example, a first container contains goods belonging to good type “A” and a second container contains goods belonging to good type ‘B’, etc. It is also possible for the containers to be divided into several container compartments by partition walls and to accommodate different good types, wherein goods belonging to good type “A” can be accommodated in the first container compartment and goods belonging to good type “B” can be accommodated in the second container compartment. However, according to the proposed embodiment, goods of a single grip type are stored in each container compartment.

It should be noted that a tray or box can also be regarded as a container. The containers generally form load carriers for the transporting goods.

Furthermore, it is favorable for the automatic sorting device to comprise a driverless transport system with one or more autonomously movable transport vehicles, wherein the transport vehicles each have a receiving platform or a suspension rod, upon which the goods are stored with or without containers or with or without a suspended bag. In this way, a particularly flexible sorting device can be constructed. An autonomously movable transport vehicle of the type used is also known by the term “autonomous guided vehicle” (abbreviated to “AGV”) or “autonomous mobile robot” (abbreviated to “AMR”). The transport vehicles can be understood not only as a (dedicated) sorting device, but also generally as part of the conveyor device.

### BRIEF DESCRIPTION OF THE DRAWINGS

The figures below elaborate on the invention to offer better understanding thereof.

The figures show in greatly simplified, schematic depiction:

FIG. 1 An oblique view of a section of a first storage and picking system example;

FIG. 2 An oblique view of a section of a second storage and picking system example;

FIG. 3A schematized plan view of the storage and picking system depicted in FIG. 2;

FIG. 4A schematized plan view of a section of a storage and picking system with an automatic sorting device;

FIG. 5A schematized plan view of a section of a storage and picking system with a sorting device comprising autonomously movable transport vehicles; and

FIG. 6 An autonomously movable transport vehicle of a transport system in oblique view.

### DETAILED DESCRIPTION OF THE PREFERRED EMBODIMENTS

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. also refer to the figure directly described and shown, and these indications of position can be applied in the same way to the new position should the position change.

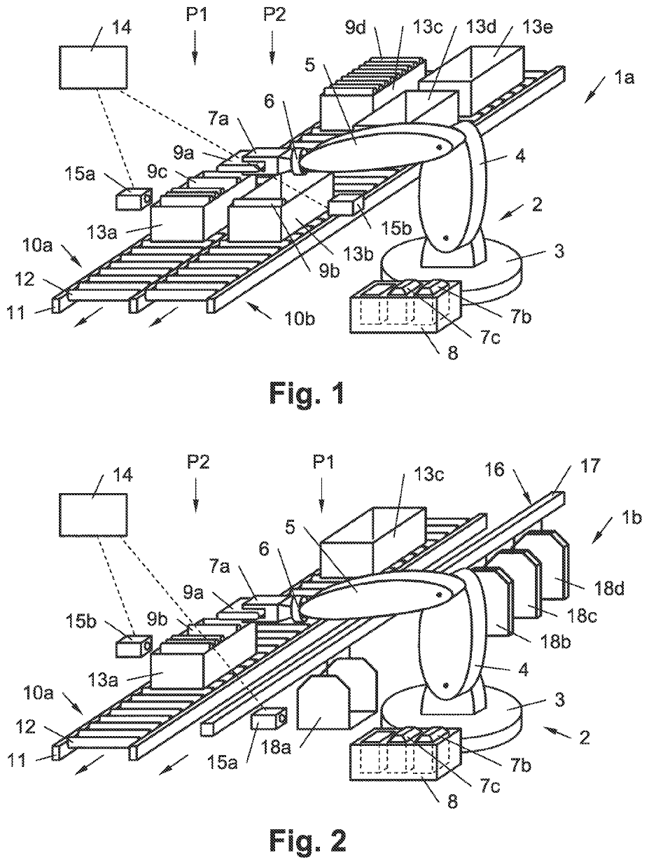

FIG. 1 shows an oblique view of a section from a first example of a storage and picking system 1a. The storage and picking system 1a comprises a robot 2, which, in this example, has a robot base 3, a first movable arm segment 4, a second movable arm segment 5 and a robot head 6 arranged on the second arm segment 5. Different grippers 7a . . . 7c can be coupled to the robot head 6. The state specifically shown in FIG. 1 is a gripper 7a coupled to the robot head 6, whereas two further grippers 7b, 7c are located in a gripper magazine 8 in the region of action of the robot 2. The robot 2 can grasp or pick up different goods 9a . . . 9d with the grippers 7a . . . 7c.

In the example shown in FIG. 1, the goods 9a . . . 9d are transported by means of a container conveyor device 10a, which has a plurality of conveying rollers 12 arranged between two frame profiles 11, to a first position P1 in a region of action of the robot 2. Furthermore, the storage and commissioning system 1a has a further container conveyor device 10b, which also has a plurality of conveying rollers 12 arranged between two frame profiles 11. The goods 9a . . . 9d are transported on the container conveying devices 10a, 10b using containers 13a . . . 13e. Specifically, the conveyor device 10a serves to transport the goods 9a . . . 9d in containers 13a, 13c, for example from a storage area, and the conveyor device 10b serves to transport empty containers 13d, 13d and transport filled containers 13b, for example to outgoing goods. In the example shown, the containers 13a, 13c thus form source load carriers, the containers 13b, 13d, 13e target load carriers.

The storage and picking system 1a further comprises an electronic control system 14, which is configured to determine grip types for the different goods 9a . . . 9d, wherein the grip type indicates with which gripper 7a . . . 7c corresponding to which gripper type gripping of the respective goods 9a . . . 9d is possible. The control system 14 is connected to a first RFID reader 15a, using which a container 13a, 13c and therefore the goods 9a . . . 9d located therein, can be identified.

The result of this identification can be used for the picking process and/or for triggering a gripper change. The grip type allocated to a good 9a . . . 9d can, for example, be stored in a database and read from this by the control system 14. For example, the grip type allocated to a good 9a . . . 9d can be stored in the master data for a good 9a . . . 9d, in particular in addition to further data, which characterize a good type of the good. The control system 14 is, in particular, a higher-level control system and not necessarily the robot control of the robot 2.

Instead of an RFID tag arranged on a container 13a . . . 13e, the container 13a . . . 13e can also have a barcode, matrix code, in particular a QR code (quick-response code) or data matrix code for the same purpose.

The reader can also be an optical or optoelectronic reader, with which the data can be machine read. The data carrier can contain data, in particular an identification number, on whose basis access to the master data can be gained, in which the grip type of this good 9a . . . 9d is stored.

However, the data carrier can also directly contain data about the grip type. In particular, the data contain an identification number and the data regarding the grip type.

Yet determining the grip type of a good 9a . . . 9d can also be carried out by recognizing the good 9a . . . 9d by means of “object recognition”. Object recognition describes a method for identifying an object by means of optical, acoustic or other physical recognition methods. In particular, after the goods 9a . . . 9d are identified by object recognition, the master data can be accessed, in which the grip types for the good are stored.

The control system 14 is further configured to select a gripper 7a . . . 7c provided on the robot 2 from the different types of grippers depending on the grip type of the goods 9a . . . 9d to be transferred and to trigger coupling of the selected gripper 7a to the robot head 6 or activation of the selected gripper 7a on the robot head 6.

With the robot 2, the good 9a . . . 9d can be gripped with the selected gripper 7a at the first position P1 in the region of action of the robot 2 and deposited at a second position P2 in the region of action of the robot 2. Specifically, goods 9a . . . 9d are removed from the containers 13a, 13c provided at the first position P1 and deposited into the containers 13b, 13d, 13e provided at the second position P2. In this way, for example, a picking method can be realized, wherein the containers 13a, 13c form source containers (for example storage containers) and the containers 13b, 13d, 13e destination containers (for example shipping containers or shipping boxes). However, the arrangement depicted in FIG. 1 can also be located at incoming goods. In this case, the container conveyor device 10a is connected to incoming goods and the container conveyor device 10b to a storage area. By doing so, the goods to be stored can be sorted before storage. To identify the target containers 13b, 13d, 13e, the control system 14 can be connected to a second RFID reader 15b.

It is favorable for only goods 9a . . . 9d of a single grip type to be stored in each source container 13a, 13c. This means that gripper 7a . . . 7c need not be changed when goods 9a . . . 9d are removed from a container 13a, 13c. For containers divided into compartments, it can also be provided that goods 9a . . . 9d of a single grip type are stored in each container compartment of the container 13a, 13c. This means that gripper 7a . . . 7c need not be changed when goods 9a . . . 9d are removed from a container compartment.

According to the invention, an (automatically operated) conveyor system, in particular the above-described container conveyor device 10a, is provided, which is configured to supply the goods 9a . . . 9d, separated into two groups of goods G1 . . . . G3, to the robot 2, wherein the goods 9a, 9c of a first group of goods G1 are provided firstly at the first position P1 and subsequently the goods 9d of a second group of goods G2 at the first position P1.

The first group of goods G1 comprises (different) goods 9a, 9c of a first grip type of the grip types, which can be gripped with the gripper 7a of a first gripper type at the first position P1 and deposited at the second position P2. The second group of goods G2 comprises (identical) goods 9d of a second grip type of the grip types, which can be gripped with gripper 7b of a second gripper type at the first position P1 and deposited at the second position P2. In other words, according to this embodiment, the goods 9a, 9c are allocated, on the one hand, to the first grip type and form the first group of goods G1 (not shown in FIG. 1) and the goods 9d, on the other hand, are assigned to the second grip type and form the second group of goods G2 (not shown in FIG. 1). Accordingly, a gripper change is necessary after the goods 9a, 9c have been deposited at the second position P2.

However, if the (different) goods 9a, 9c, 9d are all allocated to a first grip type of the grip types, the containers 13a, 13c are provided successively at the first position P1 and the goods 9a, 9c, 9d are manipulated without changing the gripper. The goods 9a, 9c, 9d are all then gripped with the gripper 7a of a first gripper type at the first position P1 and deposited at the second position P2. In other words, according to this embodiment, the goods 9a, 9c, 9d are allocated to the first grip type and form the first group of goods G1 (not shown in FIG. 1).

FIG. 2 shows an embodiment of a further storage and picking system 1b, which is very similar to the storage and picking system 1a depicted in FIG. 1. However, in contrast, instead of the second container conveyor device 10b, there is a suspended conveyor device 16 with a carrier profile 17 and suspended bags 18a . . . 18d movable along the latter, which can be transported to and away from the first position P1. WO 2020/150762 A1 describes a possible embodiment of a suspended conveyor device. In the embodiment shown, the suspended bags 18a . . . 18d form the source load carriers and the containers 13a, 13c the target load carriers. It is favorable for only a single good 9a . . . 9d (not shown) to be stored in each suspended bag 18a . . . 18d. These measures facilitate the removal of the goods 9a . . . 9d from the suspended bag 18a . . . 18d.

It is visible in FIG. 2 that the suspended bag 18a has been transported to the first position P1 and is provided there. The suspended bag 18a is switched to an open position, in which the robot 2 moves with the gripper 7a into a storage space in the suspended bag 18a and can grip/remove the good 9a. In the state depicted in FIG. 2, the good 9a has already been removed from the storage space and is deposited into the container 13a, which is in the second position P2. The goods 9b already deposited are additionally located in the container 13a. The loaded suspended bags 18b . . . 18d are switched to a closed position in which the goods (not visible in FIG. 2) are stored in a storage space and are transported in succession to the first position P1.

The arrangement depicted in FIG. 2 can in turn be arranged at a picking station or at incoming goods, for example.

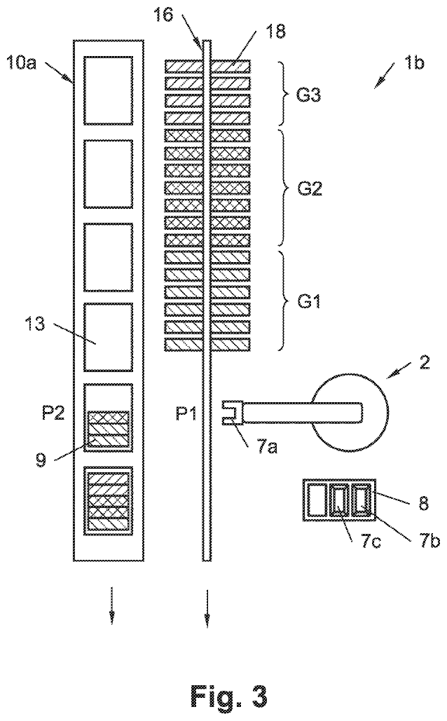

FIG. 3 shows a schematized plan view of the arrangement disclosed in FIG. 2, in which the suspended bags 18 are hatched differently depending on the grip type of the goods 9 contained in the suspended bags 18 and are sorted according to groups of goods G1 . . . . G3.

According to the invention, an (automatically operated) conveyor system, in particular the above-described suspended conveyor device 16, is provided, which is configured to supply the goods 9, separated into two groups of goods G1 . . . . G3, to the robot 2, wherein the goods 9 of a first group of goods G1 are firstly provided at the first position P1 and subsequently the goods 9 of a second group of goods G2 at the first position P1 etc.

Changing from a group of goods G1 to another group of goods G2 necessitates a gripper change. However, the same or different goods 9 with one grip type can be present within one group of goods G1.

According to the embodiment shown, similar goods of a first grip type are present in the first group of goods G1, similar goods of a second grip type in the second group of goods G2 and similar goods of a third grip type in the third group of goods G3.

The gripper 7a of the first gripper type is used in order to grip the goods 9 of the first group of goods G1; this preferably grips the goods 9 successively at the first position P1 and deposits them at the second position P2.

The gripper 7b of the second gripper type is used in order to grip the goods 9 of the second group of goods G2; this preferably grips the goods 9 successively at the first position P1 and deposits them at the second position P2.

The gripper 7c of the third gripper type is used in order to grip the goods 9 of the third group of goods G3; this preferably grips the goods 9 successively at the first position P1 and deposits them at the second position P2

An operating method of a robot 2 for transferring different goods 9, 9a, . . . 9d in a storage and picking system 1a, having the following steps:
a) determining grip types for the different goods 9, 9a . . . 9d in an electronic control system 14, wherein the grip type indicates with which gripper 7a . . . 7c corresponding to which gripper type gripping of the respective good 9, 9a . . . 9d is possible.
b) providing grippers 7a . . . 7c of different grip types at the robot 2
c) selecting a gripper 7a . . . 7c from the different gripper types depending on the grip type of the good 9, 9a . . . 9d to be transferred 7 by way of an electronic control system 14
d) coupling the selected gripper 7a . . . 7c to the robot head 6 of the robot 2 or activating the selected gripper 7a . . . 7c on the robot head 6 of the robot 2
e) providing the goods 9, 9a . . . 9d at the first position P1 in a region of action of the robot 2 and
f) gripping the goods 9, 9a . . . 9d at the first position P1, and depositing the goods 9, 9a . . . 9d at the second position P2 in the region of action of the robot 2 with the selected gripper 7a . . . 7c of the robot 2.

In addition, the different goods 9, 9a . . . 9d are sorted into goods groups G1 . . . . G3 depending on the grip type, of which, according to this embodiment, a first group of goods G1 comprises goods 9, 9a . . . 9d of a first grip type of the grip types and a second group of goods G2 comprises goods 9, 9a . . . 9d of a second grip type of the grip types and a third group of goods G3 comprises goods 9, 9a . . . 9d of a third grip type of the grip types, and the goods 9, 9a . . . 9d are separately supplied to the robot 2 according to the groups of goods G1 . . . . G3, so that the goods 9, 9a . . . 9d of the first group of goods G1 are firstly provided at the first position P1, and subsequently the goods 9, 9a . . . 9d of the second group of goods G2 at the first position P1 and finally the goods 9, 9a . . . 9d of the third group of goods G3 at the first position P1.

It should be mentioned that sorting is also possible for more than three groups of goods G1 . . . . G3 but is carried out for at least for two groups of goods G1 . . . . G2.

By forming the groups of goods G1 . . . . G3, the number of gripper changes can be reduced to a minimum even if there is an extremely broad range of goods and a correspondingly high number of different goods 9, 9a . . . 9d. The higher the number of goods 9, 9a . . . 9d in a group of goods G1 . . . . G3, the less frequent the need for a gripper change.

The different types of gripper 7a . . . 7c are described by the respectively allocated “gripper type”. Grippers 7a . . . 7c can be, for example, force-fitting grippers, form-fitting grippers or can be configured as combination grippers. The “grip type” specifies those goods 9, 9a . . . 9d that can be gripped with a specific gripper 7a . . . 7c corresponding to a specific gripper type. At the same time, the grip type is the sorting criterion for forming a group of goods G1 . . . . G3.

On the one hand, the different grippers 7a . . . 7c can be located in a gripper magazine 8 in the region of action of the robot 2 and are removed from there as required and connected to the robot head 6 as per the examples depicted in the figures. On the other hand, however, the grippers 7a . . . 7c can also be arranged permanently on the robot head 6 and be activated if necessary. For example, they can be arranged in a turret magazine on the robot head 6.

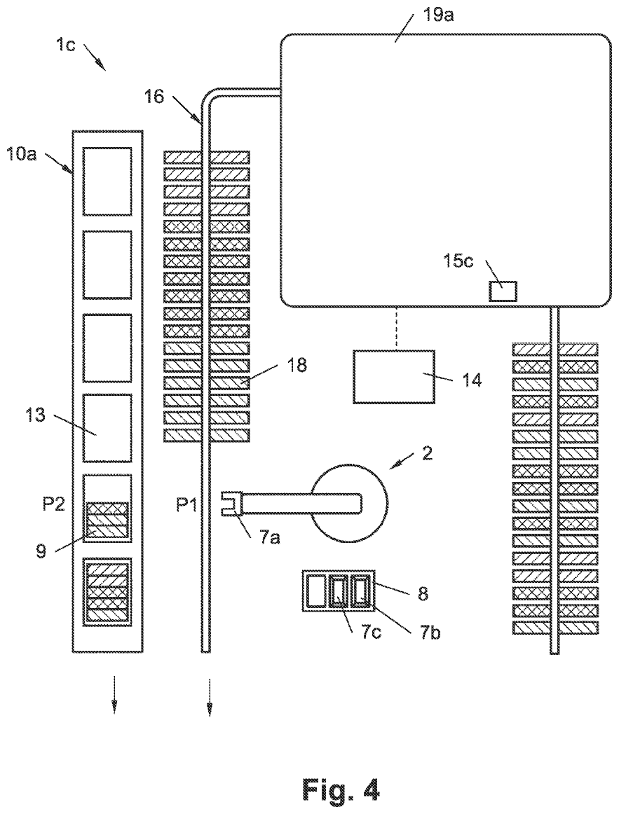

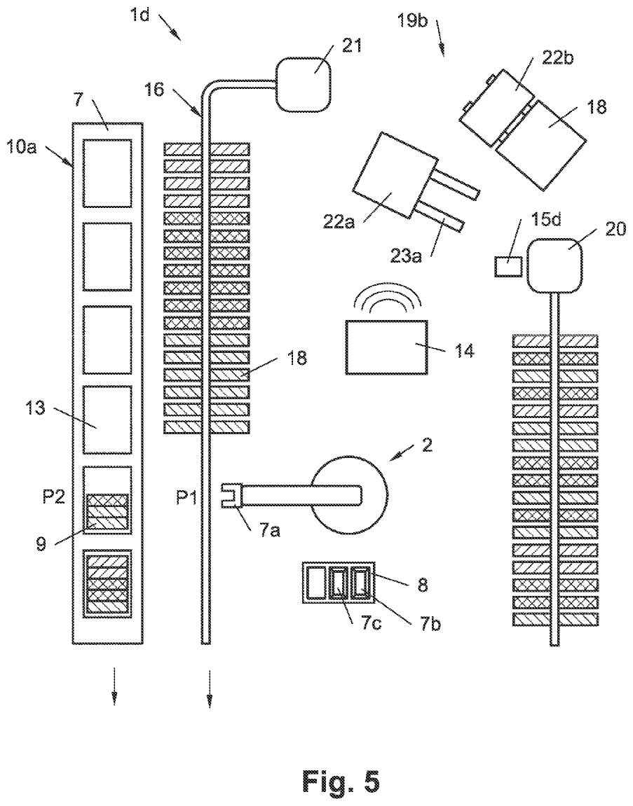

For the sake of completeness, it is noted at this point that the reader 15a cannot be used to form groups of goods G1 . . . . G3 since it is arranged too far downstream in the conveying flow. In order to form groups of goods G1 . . . . G3, goods identification therefore takes place further upstream as is the case with readers 15c, 15d in FIGS. 4 and 5, for example.

FIG. 4 shows a schematized plan view of a section from a storage and picking system 1c, which is very similar to the storage and picking system 1b shown in FIG. 3. In contrast, the storage and picking system 1c comprises an automatic sorting device 19a based on the suspended conveyor system. As the function of a sorting device 19a is fundamentally known, it is not depicted in detail in FIG. 4. FIG. 4 shows that the goods 18 are supplied to the sorting device 19a in an unordered state, sorted by the sorting device 19a into groups of goods G1 . . . . G3 and then leave the sorting device 19a separated into the groups of goods G1 . . . . G3 (see also the illustration in FIG. 3). For this purpose, the control system 14 is connected to the automatic sorting device 19a in order to control the latter. The automatic sorting device 19a also further comprises an RFID reader 15c for identifying the goods 9, 9a . . . 9d. Automatic sorting achieves particularly high sorting performance, thus enabling uninterrupted provision of the goods 9, 9a . . . 9d at the first position P1. The sorting device 19a can comprise one or more sorting stages, which are connected to one another by conveying technology. The sorting device 19a can be formed by a matrix sorter, for example. The suspended conveyor system or the suspended conveyor device 16 can also be configured in particular for transporting the suspended bags 18, 18a . . . 18d from the automatic sorting device 19a into the first position P1.

It is noted at this point that the automatic sorting device 19a can also be operated on the basis of a container conveyor system. Such a storage and picking system would be particularly suitable in combination with the storage and picking system 1a shown in FIG. 1. The container conveyor system or the container conveyor device 10a can then also be particularly configured to transport the containers 13a, 13c from the automatic sorting device 19a to the first position P1.

In addition, sorting and grouping the goods 9, 9a . . . 9d can also be carried out, for example, by correspondingly removing the goods 9, 9a . . . 9d from a warehouse of the storage and picking system 1a . . . 1c in the specific sequence or grouping by correspondingly controlling switches and mergers in the course of the conveyor device 10a, 16 and/or by using buffer locations in the course of the conveyor device 10a, 16.

FIG. 5 shows a schematized plan view of a section from a further storage and picking system 1d, which is very similar to the storage and picking system 1c shown in FIG. 4. According to this embodiment, an automatic sorting device 19b is provided, which comprises a takeover point 20, a transfer point 21 and a driverless transport system with one or more autonomously movable transport vehicles 22a, 22b. The transport vehicles 22a, 22b each have a receiving platform 23a, 23b or a suspension rod, upon which the goods 9, 9a . . . 9d are stored with or without containers 13, 13a . . . 13d or with or without a suspended bag 18, 18a . . . 18d. The transport vehicles 22a, 22b pick up the goods 9, 9a . . . d without sorting at the takeover point 20 and deposit them back in sorted order at the transfer point 21. The automatic sorting device 19b accordingly comprises a driverless transport system. For this purpose, the control system 14 is connected to the automatic sorting device 19b or to the transport vehicles 22a, 22b in order to control the latter. The automatic sorting device 19b also further comprises an RFID reader 15d at the takeover point 20 for identifying the goods 9, 9a . . . 9d. These measures mean a particularly flexible sorting device 19b can be constructed. The transport vehicles 22a, 22b can be understood not only as a (dedicated) sorting device 19b but also generally as part of the conveyor device 16.

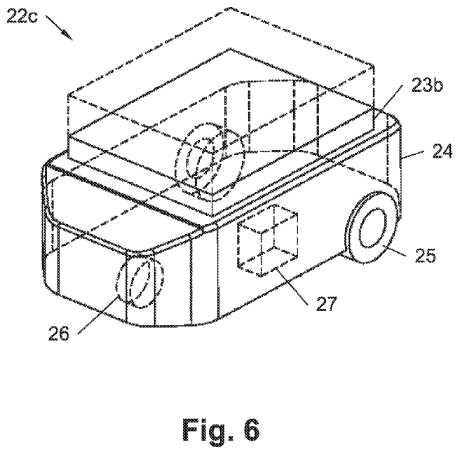

Finally, FIG. 6 shows a possible embodiment of an autonomously movable industrial truck 22c (“automated guided vehicle”, abbreviated to “AGV” or “automated mobile robot”, abbreviated to “AMR”). The autonomous industrial truck 22c comprises a chassis 24 with a drive unit and incoming goods or a loading platform 23b arranged on the chassis 23 for picking up, depositing and transporting of a good 9, 9a . . . 9d (not shown in this Fig.) or of a container 13, 13a . . . 13e (not shown in this Fig.), in which the good 9, 9a . . . 9d is stored. It would also be conceivable for the autonomous industrial truck 22c to additionally or alternatively comprise a suspension rod, which acts as incoming goods and by means of which suspended bags 18, 18a . . . 18d or suspended goods can be transported on goods transport carriers with clothes hangers or clothes hangers with the hanging goods.

The drive unit comprises wheels 25, 25 rotatably mounted on the chassis 24, at least one of the wheels 25 is coupled to a drive (not shown), and at least one of the wheels 26 is steerable. Both wheels 25, 26 can also be coupled to the drive and driven by it. However, the autonomous industrial truck 22c can also comprise four wheels, of which two wheels can be steered. According to the embodiment shown, the incoming goods 23b is adjustably stored on the chassis 24 between a starting position (shown in solid lines) and a transport position (shown in dashed lines).

In the starting position, a good 9, 9a . . . 9d or a container 13, 13a . . . 13e can be moved downwards in order to receive the former. If the incoming goods 23b is switched from the starting position to the direction of the transport position, the good 9, 9a . . . 9d or the container 13, 13a . . . 13e can be lifted and then transported. If the incoming goods 23b is switched from the transport position back to the direction of the starting position, the good 9, 9a . . . 9d or the container 13, 13a . . . 13e can be set down again or deposited.

The autonomous industrial truck 22c further comprises a control 27 shown schematically in dashed lines for controlling the movements of the autonomous industrial truck 22c. The controller 27 can also include means for (wireless) data transmission to and from the autonomous industrial truck 22c. In this way, the autonomous industrial truck 22c or its controller 27 can communicate with the control system 14 i.e. receive commands from it and transmit data to it. Finally, the autonomous industrial truck 22c comprises sensors for detecting the surroundings of the autonomous industrial truck 22c and for spatial orientation.

At this point, it is also noted that sorting the goods 9, 9a . . . d into groups of goods G1 . . . . G3 can also be carried out without an automatic sorting device 19a, 19b by corresponding automatic removal of the goods 9, 9a . . . 9d (with or without a container) from a storage area, for example.

In principle, the different goods 9, 9a . . . d can also be manually sorted into groups of goods G1 . . . . G3 depending on the grip type. The first group of goods G1 comprises the goods 9, 9a . . . 9d of a first grip type of the grip types and a second group of goods G2 comprises the goods 9, 9a . . . 9d of a second grip type of the grip types. The goods 9, 9a . . . 9d, separated into two groups of goods G1 . . . . G3, are supplied to the robot 2, in particular by the conveyor system, in particular the container conveyor device 10a and/or the suspended conveyor device 16, so that the goods 9, 9a . . . 9d of a first group of goods G1 are firstly provided at the first position P1 and the goods 9, 9a . . . 9d of a second group of goods G2 are subsequently at the first position P1. In general, sequencing of the groups of goods G1 . . . . G3 can be carried out depending on the gripper type of a gripper 7a currently activated or coupled in the robot 2, wherein goods 9, 9a . . . 9d of the first group of goods G1 . . . . G3 have a grip type, which corresponds to the gripper type of the gripper 7a currently activated or coupled in the robot 2. In this case, when the goods 9, 9a . . . 9d are suppled to the robot 2, care is taken that those goods 9, 9a . . . 9d, which can be gripped by the gripper 7a currently activated in the robot 2 or by the gripper 7a coupled to the robot 2, are first served to the robot 2. In this way, changing the gripper is advantageously avoided.

However, sequencing of the groups of goods G1 . . . . G3 can also be carried out independently of the gripper type of the gripper 7a currently activated or coupled in the robot 2. In this case, when the goods 9, 9 9a . . . 2d are supplied to the robot 2, care is not taken that those goods 9, 9 9a . . . 2d, which can be gripped by the gripper 7a currently activated in the robot 2 or by the gripper 7a coupled to the robot 2, are first served to the robot 2. Because of this, changing the gripper may be necessary to grip goods 9, 9a . . . 9d of the first group of goods G1. However, this variant of the method is advantageous if the goods 9, 9a . . . 9d of the first group of goods G1 are to be processed in a prioritized manner and a possible gripper change is therefore tolerated.

The goods 9, 9a . . . 9d can be sorted within a group of goods G1 . . . . G3 to a good type in an article-by-article or chaotic manner. Article-by-article sorting is particularly advantageous at an incoming goods, for example, when goods are to be stored article by article or when picking goods in the B2B sector, since many goods 9, 9a . . . 9d of a good type are often ordered in this sector, which are subsequently stored in a shop in an article-by-article manner. A chaotic arrangement is advantageous at incoming goods if goods 9, 9a . . . 9d are to be stored chaotically, for example. Furthermore, this embodiment is particularly advantageous for picking goods 9, 9a . . . 9d in the e-commerce or B2C sector, since few goods 9, 9a . . . 9d of many different good types are often ordered in these sectors, which are packed as a block in a shipping box.

It is noted at this point that the construction of the robot 2 shown in FIG. 1 as a multi-axis robot or articulated-arm robot is purely exemplary. Instead, the robot 2 could also be designed as a portal robot or also as a mixed form of the two construction types.

Finally, it is further stated that the scope of protection is determined by the claims. However, the description and the drawings are to be referenced for the interpretation of the claims. Individual features or combinations of features from the different exemplary embodiments shown and described can represent independent inventive solutions in themselves. The problem to be solved, upon which the independent, inventive solutions are based, can be derived from the description.

It is also particularly stated that the devices shown can, in reality, also comprise more or even fewer components than those shown. In some cases, the devices shown or their components have not been shown to scale and/or enlarged and/or shrunk.

### LIST OF REFERENCE NUMERALS

1a . . . 1d Storage and picking system (section)
2 Robot
3 Robot base
4 First arm segment
5 Second arm segment
6 Robot head
7a . . . 7c Gripper
8 Gripper magazine
9, 9a . . . 9d Good
10a, 10b Container conveyor device/roller conveyor
11 Frame profile
12 Conveying roller
13, 13a . . . 13e Container
14 Electronic control system.
15a . . . 15d RFID reader
16 Hanging conveyor device
17 Support profile
18, 18a . . . 18d Suspended bag
19a, 19b Automatic sorting device
20 Takeover point
21 Transfer point
22a, 22b Autonomous transport vehicle
23a, 23b Receiving platform
24 Chassis
25 Wheel (driven)
26 Wheel (steerable)
27 Drive control
P1 First position
P2 Second position
G1 . . . . G3 Group of goods

1. An operating method of a robot (2) for transferring different goods (9, 9a . . . 9d) in a storage and picking system (1a . . . 1d), comprising the steps
a) determining grip types for the different goods (9, 9 9a . . . 9d) in an electronic control system (14), wherein the grip type indicates with which gripper (7a . . . 7c) corresponding to with which gripper type gripping of the respective good (9, 9a . . . 9d) is possible;
b) providing grippers (7a . . . 7c) of different gripper types;
c) selecting a gripper (7a . . . 7c) from the different gripper types depending on the grip type of the good (9, 9a . . . 9d) to be transferred by way of an electronic control system (14);
d) coupling the selected gripper (7a . . . 7c) to a robot head (6) of the robot (2) or activating the selected gripper (7a . . . 7c) on a robot head (6) of the robot (2);
e) providing the goods (9, 9a . . . 9d) at a first position (P1) in a region of action of the robot (2); and
f) gripping the goods (9, 9a . . . 9d) at the first position (P1) and depositing the goods (9, 9a . . . 9d) at a second position (P2) in the region of action of the robot (2) with the selected gripper (7a . . . c) of the robot (2) further comprising the steps
sorting the different goods (9, 9a . . . 9d) into groups of goods (G1 . . . . G3) depending on the grip type, of which a first group of goods (G1) comprises goods (9, 9a . . . 9d) of a first grip type of the grip types and a second group of goods (G2) comprises goods (9, 9a . . . 9d) of a second grip type of the grip types and
supplying the goods (9, 9a . . . 9d), separated into the groups of goods (G1 . . . . G3), to the robot (2) so that firstly the goods (9, 9a . . . 9d) of the first group of goods (G1) and subsequently the goods (9, 9a . . . 9d) of the second group of goods (G2) are provided at the first position (P1).

2. The method according to claim 1, wherein the goods (9, 9a . . . 9d) are sorted within a group of goods (G1 . . . . G3) according to a good type of the goods (9, 9a . . . 9d) in a type-by-type manner.

3. The method according to claim 1, wherein the goods (9, 9a . . . 9d) are arranged within a group of goods (G1 . . . . G3) according to a good type of the goods (9, 9a . . . 9d) in a chaotic manner.

4. The method according to claim 1, wherein sequencing of the groups of goods (G1 . . . . G3) is carried out depending on the gripper type of a gripper (7a . . . 7c) currently activated in or coupled to the robot (2), wherein goods (9, 9a . . . 9d) of the first group of goods (G1 . . . . G3) have a grip type, which corresponds to the gripper type of the gripper (7a . . . 7c) currently activated in or coupled to the robot (2).

5. The method according to claim 1, wherein sequencing of the groups of goods (G1 . . . . G3) is carried out independently of the gripper type of the gripper (7a . . . 7c) currently activated in or coupled to the robot (2).

6. The method according to claim 1, wherein sorting the different goods (9, 9a . . . 9d) into groups of goods (G1 . . . . G3) is carried out depending on the grip type by an automatic sorting device (19a, 19b), which, in turn, is connected to the electronic control system (14) in order to control the automatic sorting device (19a, 19b).

7. The method according to claim 6, wherein the automatic sorting device (19a, 19b) comprises an overhead conveyor system and hanging bags (18, 18a . . . 18d), wherein the goods (9, 9a . . . 9d) are stored in the hanging bags (18, 18a . . . 18d).

8. The method according to claim 7, wherein only a single good (9, 9a . . . 9d) is stored in each hanging bag (18, 18a . . . 18d).

9. The method according to claim 6, wherein the automatic sorting device (19a, 19b) comprises a container conveyor system and containers (13, 13a . . . 13d), wherein the goods (9, 9a . . . 9d) are stored in the containers.

10. The method according to claim 9, wherein only goods (9, 9a . . . 9d) of a single grip are stored in each container (13, 13a . . . 13d).

11. The method according to claim 6, wherein the automatic sorting device (19a, 19b) comprises a driverless transport system with one or more autonomously movable transport vehicles (22a . . . 22c), wherein the transport vehicles (22a . . . 22c) each have a receiving platform (23a, 23b) or a suspension rod, upon which the goods (9, 9a . . . 9d) are stored with or without containers (13, 13a . . . 13d) or with or without a suspended bag (18, 18a . . . 18d).

12. A storage and picking system (1a . . . 1d) comprising:
a robot (2) for transferring goods (9, 9a . . . 9d), comprising a robot head (6) and at least two different grippers (7a . . . 7c), which can be alternately coupled to the robot head (6) or at least two different grippers (7a . . . 7c) arranged on the robot head, which can be activated alternately, and
an electronic control system (14), which is configured to detect determine the grip types for the different goods (9, 9a . . . 9d), wherein the grip type indicates with which gripper (7a . . . 7c) corresponding to which gripper type gripping of the respective good (9, 9a . . . 9d) is possible, and which is further configured to select a provided gripper (7a . . . 7c) from the different grip types depending on the grip type of the good to be transferred and trigger coupling of the selected gripper (7a . . . 7c) to the robot head (6) or activating of the selected gripper (7a . . . 7c) on the robot head (6), and
a conveyor system (10a, 16), which is configured to transport goods (9, 9a . . . 9d) to a first position (P1) in a region of action of the robot (2),
wherein the robot (2) is configured to grip the good (9, 9a . . . 9d) with the selected gripper (7a . . . 7c) at the first position (P1) in the region of action of the robot (2) and to deposit the good (9, 9a . . . 9d) at a second position (P2) in the region of action of the robot (2)
characterized in that
the conveyor system (10a, 16) is further configured to supply the goods (9, 9a . . . 9d), separated into groups of goods (G1 . . . . G3), to the robot (2), wherein firstly the goods (9, 9a . . . 9d) of a first group of goods (G1) and subsequently the goods (9, 9a . . . 9d) of a second group of goods (G2) are provided at the first position (P1), wherein the first group of goods (G1) comprises goods (9, 9a . . . 9d) of a first grip type of the grip types and the second group of goods (G2) comprises goods (9, 9a . . . 9d) of a second grip type of the grip types.

13. The storage and picking system according to claim 12, comprising an automatic sorting device (19a, 19b) connected to the conveyor system (10a, 16) by conveying means or comprising an automatic sorting device (19a, 19b) comprising the conveyor system (10a, 16), wherein the sorting device (19a, 19b) is connected to the electronic control system (14) in a controllable manner and is controlled by the control system (14) in such a way that the different goods (9, 9a . . . 9d) are sorted into groups of goods (G1 . . . . G3) depending on the grip type.

14. The storage and picking system according to claim 13, wherein the automatic sorting device (19a) comprises an overhead conveyor system and hanging bags (18, 18a . . . 18d), wherein the goods (9, 9a . . . 9d) are stored in the hanging bags (18, 18a . . . 18d).

15. The storage and picking system according to claim 13, wherein the automatic sorting device (19a) comprises a container conveyor system and containers (13, 13a . . . 13d), wherein the goods (9, 9a . . . 9d) are stored in the containers (13, 13a . . . 13d).

16. The storage and picking system according to claim 14, wherein:
the conveyor system comprises an overhead conveyor system for transporting the hanging bags (18, 18a, 18d) from the automatic sorting device (19a) to the first position (P1) or is formed by such an overhead conveyor system, or
the conveyor system comprises a container conveyor system for transporting the containers from the automatic sorting device (19a) to the first position (P1) or is formed by such a container conveyor system.

17. The storage and picking system according to claim 13, wherein the automatic sorting device (19b) comprises a driverless transport system with one or more autonomously movable transport vehicles (22a . . . 22c), wherein the transport vehicles (22a . . . 22c) each have a receiving platform (23a, 23b) or a suspension rod, upon which the goods (9, 9a . . . 9d) can be stored with or without containers (13, 13a . . . 13d) or with or without a hanging bag (18, 18a . . . 18d).
